(19) United States
(12) Patent Application Publication
(10) Pub. No.: US 2025/0157225 A1
(43) Pub. Date: May 15, 2025

(54) ON-BOARD CAMERA, STORAGE PROCESSOR, AND METHOD FOR WIRELESS ACQUISITION OF IMAGES

(71) Applicant: Mitsubishi Electric Automotive America, Inc., Mason, OH (US)

(72) Inventors: Matheus F. DE ALMEIDA, Northville, MI (US); Michael D. HORANI, Northville, MI (US); Aneek SARKER, Northville, MI (US)

(21) Appl. No.: 18/509,745

(22) Filed: Nov. 15, 2023

(51) Int. Cl. G06V 20/56; G06T 1/60

(52) U.S. Cl. CPC G06V 20/56; G06T 1/60

(57) ABSTRACT

On-board cameras installed on traveling vehicles collect image data while traveling. Responsive to an on-board camera being in range of a local area network for direct wireless communication, a storage processor acquires recorded image data from an image memory of the on-board camera. The on-board camera includes processor(s) and/or circuitry that store raw camera image data in the image memory of the on-board camera; determine whether the on-board camera is in range for returned-to-garage communication directly over the wireless connection to a computing system predefined for image acquisition; responsive to determining that the on-board camera is in range, trigger an acquisition communication of the recorded data from the image memory to a storage of the computing system; and perform the acquisition communication, responsive to being triggered, of the recorded data from the image memory. The recorded data which is communicated by the acquisition communication includes the raw camera image data.

### TECHNICAL FIELD

The technical field relates in general to systems and methods for communication with an on-board camera.

### BACKGROUND

An on-vehicle camera, such as a dashboard camera, smart phone, or a smart camera, is mounted on a vehicle and captures images while the vehicle is traveling. While the vehicle is traveling on the road, for example, the on-vehicle camera mounted on the vehicle is collecting image data (which may be, e.g., video data), and other data in the field.

Each camera has its own built-in memory where the data is stored. Over a period of two to three weeks, after the camera has stored the images from traveling, a human may be sent to swap the memory from the camera and physically put a new storage device in the camera and take the filled memory back to the server and load it into a server.

In an example, the data can be transmitted wirelessly from the on-board camera, however, a live video stream from a traveling vehicle to a cellular network is not practical or economical due to bandwidth, the extensive amount of data, and/or gaps in cellular coverage.

EP 3 975 133 A1 to Cowley, et al., provides circuitry associated with the camera to analyze the images captured by the camera and identify regions of greater and lesser interest in the images; the circuitry then processes the image data to reduce information in regions of lesser interest, and generates compressed image data, which is transmitted to a remote host over a wireless cellular network.

EP 4 202 371 A1 to Tal et al. discloses a system and method for, e.g., transmission of surveying data across a road network, that automatically determines when to collect, store, process and transmit data such that the right data is collected at the right place and time; the data acquisition device itself performs data processing functions, helping to reduce the processing load on the server; by connecting to a cellular network, wireless network, and/or the internet, the device can communicate with a server and download the stored data. Collection instructions, which may be dictated/changed by the server, can be used to optimize the acquisition of digital images and sending (or not) of the collected data to the server.

### SUMMARY

Accordingly, one or more embodiments provide an apparatus, method, and/or computer-readable medium. In an embodiment, there is provided an on-board camera in a business network for wireless acquisition of images from cameras installed on traveling vehicles which image while traveling, the network including a first storage processor which, responsive to the on-board camera being in range for direct wireless communication therewith, acquires recorded image data from an image memory of the on-board camera. The on-board camera includes the image memory; and at least one processor and/or circuitry. The processor(s) and circuitry are configured to store raw camera image data as recorded data in the image memory of the on-board camera; determine whether the on-board camera is in range for returned-to-garage communication directly over a wireless connection to a computing system predefined for image acquisition; responsive to determining that the on-board camera is in range, trigger an acquisition communication of the recorded data from the image memory to a storage of the computing system; and perform the acquisition communication, responsive to being triggered, of the recorded data from the image memory. The recorded data which is communicated by the acquisition communication includes the raw camera image data.

In an embodiment, the processor(s) and/or circuitry is further configured to upload, as the acquisition communication, the images from the image memory; and track which among the images in the image memory have been uploaded to the storage of the computing system, wherein the images which are uploaded are those which are determined to have not been previously transmitted.

In at least one embodiment, the processor(s) and/or circuitry is further configured to offload, as the acquisition communication, the images from the image memory; and track which among the images in the image memory have been offloaded to the storage of the computing system so as to recover from an interruption of the acquisition communication.

In an embodiment, the processor(s) and/or circuitry is further configured to maintain power-on to the on-board camera for a duration of the acquisition communication of the recorded data to the storage of the computing system.

In an embodiment, the processor(s) and/or circuitry is further configured to, after an interruption of the wireless connection and/or after an interruption of power to the on-board camera, resume the acquisition communication of the recorded data from the image memory of the at least one camera to the storage of the computing system.

In an embodiment, recorded data which is communicated by the acquisition communication further includes location data where the image was acquired, a camera identification identifying the on-board camera which corresponds to the raw camera image data, and/or a date corresponding to the raw camera image data.

Another embodiment provides a first storage processor in a business network for wireless acquisition of images from on-board cameras installed on traveling vehicles which image while traveling. The first storage processing includes a memory; and one or more processor(s) and/or circuitry. The processor(s) and/or circuitry are configured to, responsive to one or more camera of the on-board cameras being in range for direct wireless communication therewith, acquire the recorded data from an image memory of the at least one camera to a first storage, wherein the recorded data which is acquired includes the raw camera image data

In an embodiment, the at least one first storage processor and/or circuitry is further configured to select, from the data in the first storage, portions of the data corresponding to predetermined criteria of a second storage processor as curated data, and transmit the curated data to the second storage processor.

In an embodiment, the at least one first storage processor and/or circuitry is further configured to clean the data in the first storage which has been acquired during a predefined acquisition period, prior to selecting from the data in the first storage as the curated data.

In an embodiment, the at least one first storage processor and/or circuitry is further configured to process the data on the first storage according to a predefined model corresponding to the second storage processor, and transmit the processed data to the second storage processor over a wireless connection.

In embodiment, the at least one first storage processor and/or circuitry is further configured to responsive to the predefined acquisition period expiring, perform the selecting of the curated data and the transmitting of the curated data.

Another embodiments provides a method for providing wireless acquisition of images from at least one camera installed on a traveling vehicle which images while traveling. The method includes, by the on-board camera having an image memory and at least one processor and/or circuitry, storing raw camera image data as recorded data in the image memory of the on-board camera; determining whether the on-board camera is in range for returned-to-garage communication directly over a wireless connection to a computing system predefined for image acquisition; responsive to determining that the on-board camera is in range, triggering an acquisition communication of the recorded data from the image memory to a storage of the computing system; and performing, responsive to being triggered, the acquisition communication of the recorded data from the image memory. The recorded data which is communicated by the acquisition communication includes the raw camera image data.

In an embodiment, the on-board camera performs tracking which among the images in the image memory have been transmitted to the storage of the computing system. The images which are transmitted are those which are determined to have not been previously uploaded.

An embodiment further includes, by the on-board camera, maintaining power-on to the on-board camera for a duration of the acquisition communication of the recorded data to the storage of the computing system.

An embodiment further includes, by the on-board camera, after an interruption of the wireless connection and/or after an interruption of power to the on-board camera, resuming the acquisition communication of the recorded data from the image memory of the at least one camera to the storage of the computing system.

An embodiment further includes, by a first storage processor being the predefined computing system, responsive to the on-board camera being in range of the wireless connection of the predefined computing system for direct wireless communication therewith, acquire the recorded data from the image memory of the at least one camera to a first storage; selecting. from the data in the first storage, portions of the data corresponding to predetermined criteria of a second storage processor as curated data; and transmitting the curated data to the second storage processor.

An embodiment further includes, by the second storage processor, responsive to receipt of the curated data, processing the curated data.

An embodiment further includes, by the first storage processor, cleaning the data in the first storage which has been acquired during a predefined acquisition period, prior to selecting from the data in the first storage as the curated data.

An embodiment further includes, by the first storage processor, processing the data on the first storage according to a predefined model corresponding to the second storage processor, and transmitting the processed data to the second storage processor over a further wireless connection.

An embodiment further includes, by the first storage processor, responsive to the predefined acquisition period expiring, performing the selecting of the curated data and the transmitting of the curated data.

An embodiment further includes, by the second storage processor, processing the curated data according to a predefined machine learning model.

Another embodiment can be a method of performing any or all of the above.

Still another embodiment can be one or more non-transitory computer readable storage mediums comprising instructions for the described method and/or apparatus.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the present disclosure.

FIG. 1 is a diagram illustrating a high level simplified and representative environment for acquisition of images on on-board cameras according to a first embodiment.

FIG. 2 is a diagram illustrating a simplified and representative environment for acquisition of images from on-board cameras according to the first embodiment.

FIG. 3 is a block diagram illustrating portions of an on-board camera and networks arranged for acquisition of images according to the first embodiment.

FIG. 4 is a diagram illustrating a simplified and representative environment for acquisition of images from on-board cameras according to a second embodiment.

FIG. 5 is a block diagram illustrating portions of an on-board camera and networks arranged for acquisition of images according to the second embodiment.

FIG. 6 is a block diagram illustrating portions of the on-board camera.

FIG. 7 is a block diagram illustrating portions of the computing system for image acquisition/first storage processor with network according to the first embodiment.

FIG. 8 is a block diagram illustrating portions of the computing system for image acquisition/first storage processor with network according to the second embodiment.

FIG. 9 is a block diagram illustrating portions of the second storage processor with network.

FIG. 10 is a flow chart illustrating a procedure to perform acquisition of wireless images from an on-board camera, performed on the on-board camera.

FIG. 11 is a flow chart illustrating a procedure to acquire camera images, performed on the first storage processor.

FIG. 12 is a flow chart illustrating a procedure to curate image data in the first storage, performed on the first storage processor.

FIG. 13 is a flow chart illustrating a procedure to process curated data, performed on the second storage processor.

FIG. 14 is a diagram illustrating a prior art processing of camera images by the on-board unit and the uploading to the data storage and processing, while on the road through a cellular connection.

FIG. 15 is a diagram illustrating a prior art processing of camera images by the on-board unit and the uploading to the data storage and processing through a cloud network.

### DETAILED DESCRIPTION

In overview, the present disclosure concerns challenges related to time-consuming data collection, data loading of images from an on-board camera onto a storage server, and optional model processing. While conventional solutions may utilize edge deployment or cloud features (for example, AWS (AMAZON™ Web Services) cloud platform, and AZURE™ cloud services), these technologies may present challenges as to how to minimize changes to an existing setup for on-board cameras, how to avoid the high costs associated with cloud storage and data transfer using mobile networks, and how to maintain maximum computing performance on a local high-performance computer.

Further consideration is given to certain limitations when running, for example, additional processing such as a machine learning model, on an edge device due to the limitation of computing power on edge devices such as an on-board camera.

Furthermore, using cellular connections for transmission of the image data presents a problem because cellular is metered and costly. Therefore using cellular connections to transmit image data, which will be many megabytes, can be very expensive.

More particularly, various inventive concepts and principles are embodied in systems, devices, and methods therein that improve the current model detection process by providing a workflow that significantly reduces the time it takes from data collection to the end of the cycle.

As further discussed, the on-board cameras are mounted on vehicles, such as trucks; an on-board camera will connect to a wireless network, such as a WI-FI™ network, in response to the vehicle on which it is mounted entering a garage where such vehicles are expected to be parked from time-to-time such as at an end-of-shift after the camera's storage has acquired large amounts of image data. In the garage is located a wireless network, such as a secure and/or whitelisted network, which has a limited range. The on-board camera arriving in range of the secure and/or whitelisted network triggers a connection to a computing system, which may be a NUC (Next Unit of Computing) computing system (NUC PC) for acquisition of image data from the on-board camera without needing further processed by the on-board camera. As there may be large numbers of vehicles in the fleet, each of which has acquired significant amounts of image data while traveling, taking advantage of the expected duration of stay in the garage to automatically perform the acquisition of the image data from the on-board cameras via a private wireless network can be a significant time and cost saving, without requiring the edge devices to perform additional data manipulation. The computing system itself may run processes on the image data, for example, a filter, and/or a machine learning model to curate the data, reducing the data size, optionally for further transfer.

The present disclosure relates to a unique method and system for wireless acquisition of image data and data processing in a controlled environment. Cameras mounted on vehicles connect to a wireless network, e.g., a Wi-Fi, upon entering the garage, triggering a connection to the computing system to begin acquiring the image data recorded throughout the day to a first local storage server. The computing system may then perform further processing, e.g., filtering and/or running a first machine learning model to curate the data, omitting duplicate data, or the like, consequently reducing the size of the date for optional further transfer. The filtered and/or curated and/or further processed data optionally may be sent for further processing on a more powerful computer, e.g., to a second local storage server, which may be a high-performance computer (HPC), prompting the high-performance computer (HPC) to process the data using a more powerful model. The entire process can have a turnaround of about one day, or as often as the vehicle on which the camera is mounted is returned to the garage such as at the end of a day. This offers high accuracy in detection while avoiding expensive data transfer costs incurred through mobile networks.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly or necessarily limited to a particular order; i.e., processes or steps that are not so limited may be performed in any order.

As further discussed herein below, various inventive principles and combinations thereof are advantageously employed to minimize or entirely eliminate the task of video processing of the image data entirely from the cameras, which will minimize changes to an on-board camera, avoid the high costs associated with cloud storage and data transfer using mobile networks, avoid additional processing on the edge device, e.g., on-board camera, to the extent possible, support computing performance on, e.g., a local high-performance computer for efficiency, and provide an overall workflow from acquisition of the stored image data on the on-board camera, though data acquisition to the end of the cycle with significantly reduced time.

A point which is grasped by the present inventors is that the fleet vehicles each goes on a trip which ordinarily will be a round trip, which could be along a route which may be pre-planned, for, e.g., an express purpose of imaging, or transportation where the imaging is ancillary, or data collection, or the like, usually for a work day, and then the each of the vehicles is returned to a central location, typically the same place, e.g., the garage where the vehicles in the fleet are parked, stored and/or serviced, usually between shifts or overnight. The present inventors understood that the routine return to the garage and stay for a duration of minutes or hours presents a window when the vehicles are parked and the imaging is inactive, and before they are sent on their next run. The inventors have prepared an approach involving using the on-board camera to collect raw image data according to the usual techniques without modification; what may be embodied as an application is running on the on-board camera, which takes not once the camera's built-in local network wireless connection is connected to a pre-specified local wireless network in the garage, such as a Wi-Fi network, the acquisition of all of the raw image data stored in the camera image data storage is triggered. The acquisition of the image data can be limited to transferring on white-listed network(s), for security purposes. The network side does not need any special software, to perform the acquisition. The raw image data therefore can be securely acquired onto a local server.

This allows processing of a high accuracy detection model at a fast pace while avoiding the high cost of data transfer incurred for data transfer using a mobile network. In other words, this can provide a fast turn-around while minimizing data-transfer cost associated with a mobile network, maintain the use of the in-house high-performance computer (HPC) to process the data, and prevent storage issues on cameras.

Further in accordance with exemplary embodiments, there is provided an on-board camera, a storage processor, a system having the foregoing, and/or a method for wireless acquisition of images.

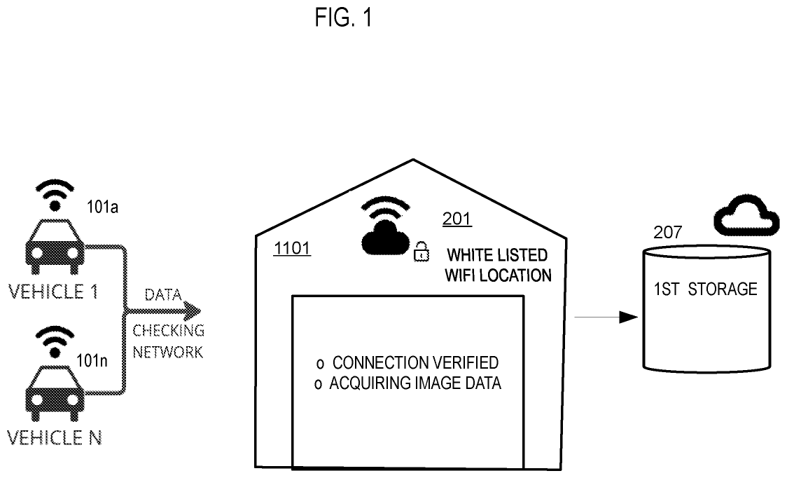

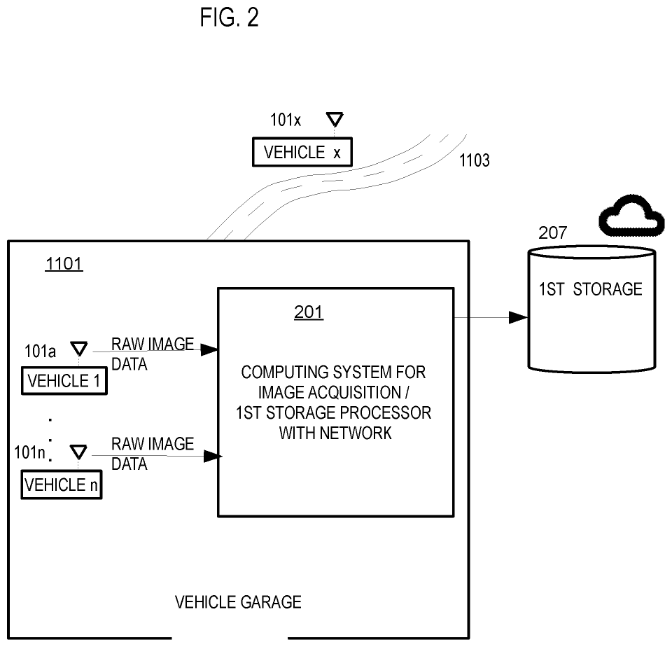

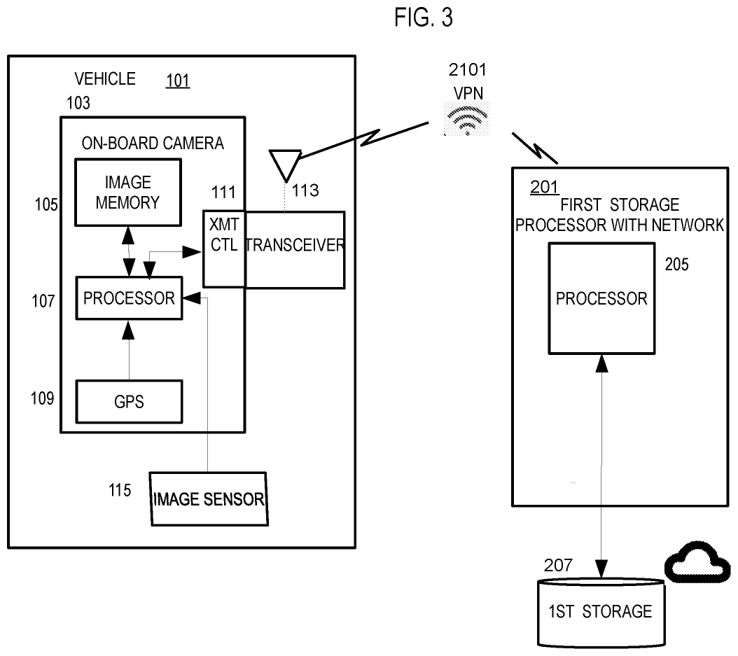

FIG. 1, FIG. 2 and FIG. 3 disclose a first embodiment. FIG. 1 provides an introductory discussion of the concepts herein; further discussion of the first embodiments is provided in connection with FIG. 2; and FIG. 3 provides additional discussion regarding implementation of the on-board camera, the local network, and the first storage processor.

Referring now to FIG. 1, a diagram illustrating a high level simplified and representative environment for acquisition of images on on-board cameras according to a first embodiment will be discussed and described. FIG. 1 illustrates vehicles 101a to 101n, a vehicle garage 1101, a computing system for image acquisition 201, and a first storage 207.

The vehicles 101a to 101n, represented by two vehicles, are examples of traveling vehicles, which are each equipped with one or more on-board cameras. The vehicle garage 1101 is an example of traveling vehicle parking. The vehicle garage 1101 is equipped with a network, for example, a local area network or a business network, having a wireless computer network which covers a limited area, for example, the garage. The network may be a private area network, may be implemented as, for example, Wi-Fi, and may support wireless communications to interconnect computers within the limited geographic area. The network may be pre-defined for image data acquisition, and may be predefined as a secure connection, for example, a white-listed WiFi location, and optionally may require a password. The computing system 201 for image acquisition/first storage processor with network may connect to the network. The first storage 207 may have a large capacity data storage. In some embodiments, the first storage 207 is provided in the cloud.

On-board cameras attached to vehicles represented by Vehicle 1 to Vehicle N 101a, 101n will automatically check for the network and automatically connect to Wi-Fi which is detected once they enter the garage 1101. Additional details are provided below. The connection triggers the on-board camera to begin sending the image data recorded throughout the day, which is acquired by the computing system 201 and stored in the first storage 207. The image data that is acquired includes the raw image data which is imaged and stored by the on-board camera, while the vehicle is traveling. Such image data could be, by way of example, images of the road, images of environmental conditions, images of traffic, or the like. The image data may include location information, for example, GPS or alternatives, geospatial data, or map coordinates. The image data may include a camera identifier which uniquely identifies the camera. Thus, the collection of the image data is meant to have a turnaround of about once a day, corresponding to the periodicity of vehicle return to the garage, which is not as fast as a processing image data at the on-board camera or otherwise on edge, but the entirety of the collected image data may be further processed at a higher performance system in one or more embodiments discussed below.

Referring now to FIG. 2, a diagram illustrating a simplified and representative environment for acquisition of images from on-board cameras according to the first embodiment will be discussed and described. FIG. 2 illustrates vehicles 101a to 101n, vehicle x 101x, the vehicle garage 1101, the computing system 201 for image acquisition, the first storage 207, and a road 1103.

The vehicles 101a to 101n, and 101x are examples of traveling vehicles equipped with on-board cameras). The computing system 201 is for image acquisition and may include a first storage processor with the local area network, which is positioned so that the local area network is limited so as to be accessible to vehicles within the vehicle garage 1101. As illustrated, vehicle x 101x is in the field, away from the vehicle garage 1101, as represented by being on the road 1103. While traveling on the road 1103, the vehicle x 101x is not connectable to the local network which has a limited area of connection limited approximately to the vehicle garage 1101. While traveling and thus while not connected to the network of the computing system 201, the on-board camera mounted on vehicle x 101x continues to image and store image data in the on-board camera, without sending the image data to the computing system 201. By comparison, vehicles 1 and n 101a, 101n are located in the vehicle garage 1101, for example, having completed a trip and thus on-board cameras mounted thereon have collected and stored raw image data, which is expected to be one trip's worth of image data. The on-board camera on vehicle 1 101a, has detected a wireless connection to the local area network, which may be white-listed, thus triggering the acquisition by the computing system 201 of the raw image data from vehicle's on-board camera; the computing system 201 stores the raw image data, for example, on the first storage 207, which may be in the cloud as illustrated or which may be distributed or local, for further processing. For example, it is possible that some data may be of duplicative locations, or may be less reliable (e.g., due to conditions), or otherwise may be omitted or compressed, etc. Similarly, the on-board camera on vehicle n 101n detects the wireless connection to the local area network and has triggered the acquisition of the raw image data from that vehicle's on-board camera. Thus, raw image data from vehicles in a fleet may be routinely acquired in a timely manner on a routine, predictable basis upon completion of daily routes, e.g., return trips, during the times that the vehicles are parked in the vehicle garage 1101.

Referring now to FIG. 3, a block diagram illustrating portions of an on-board camera and networks arranged for acquisition of images according to the first embodiment will be discussed and described. FIG. 3 illustrates a vehicle 101, the first storage processor 201, the first storage 207, and a virtual private network (vpn) 2101.

The local area network is represented by the virtual private network 2101 which communicates wirelessly with the on-board camera 103 and the first storage processor 201. The vehicle 101, representative of one of the vehicles in a fleet of vehicles, is equipped with an on-board camera 103. The on-board camera 103 may include an image memory 105, a processor 107, a global positioning system 109, a transmission control 111, a transceiver 113, and an image sensor 115.

The on-board camera 103 may be, for example, a dash cam, a smart phone, a smart camera device with wireless connection, or the like. The on-board camera 103 may be mounted on the vehicle 101, for example, on a windshield or the vehicle body; on-board camera 103 may be removable, or may attached permanently or primarily to one vehicle. While the vehicle 101 is traveling on the road, the on-board camera 103 collects image data sensed by the image sensor 115, optionally together with geographic location information (such as, e.g., GPS information from the GPS 109), date/time information, and/or other sensor information. The image data represents data captured within the field of view of the image sensor 115. The image data which is collected by the on-board camera is referred to as “raw image data”. The raw image data is stored by the processor 107 into the image memory 105.

The on-board camera may include one or more cameras, here represented by the image sensor 115. The image data can be collected individually, or image data may be collected simultaneously from multiple image sensors and/or cameras if used. The image sensor 115, representative of camera(s), can be internal or external to the on-board camera and may be connected through a wired or wireless interface. The image data can be transmitted from the transceiver 113 as raw image data.

The on-board camera 103 may include transmission control 111 circuitry which controls a transceiver 113 so as to connect to a local virtual private network 2101, which may be for example a Wi-Fi network, and to transmit raw image data from the image memory 105.

The first storage processor 201 with network may include a processor 205 which receives the raw image data over the virtual private network 2101 and stores the raw image data onto the first storage 207. The raw image data on the first storage 207 may be further processed in accordance with, for example, data analysis, filtering, curation, machine learning, and/or model processing.

The on-board camera 103 will not connect to the virtual private network 2101 which has a limited range unless the on-board camera is in range, for example, in the garage, or in a specific area of the garage, associated with the virtual private network 2101 and the first storage 207. The vehicle 101 normally is not located in the garage unless the vehicle 101 has been returned for the day, e.g., the vehicle has completed its travelling route for the day and is expected to be parked and inactive, e.g., until the next shift or for the remainder of a 24-hour period. Each vehicle 101 in the fleet may have its own traveling route and its own individual timing for respective round trips returning to the garage. The duration that the vehicle 101 is parked in the garage is expected to be at least sufficient for transmitting the raw image data stored in the image memory 105 to the first storage processor 201 over the virtual private network 2101.

Accordingly, a known problem related to the difficulty of putting a segmentation model on the edge is solved, i.e., the raw image data is acquired in batches as the vehicles are parked, and then is thereafter further processed so that there is no additional processing of the raw image data on the edge device (e.g., on the vehicle). This avoids the limitations of attempting to run a compute-intensive process on the edge device with limited computing power, such as segmentation models which require more processing power. This provides a solution which allows for use of all models regardless of weight.

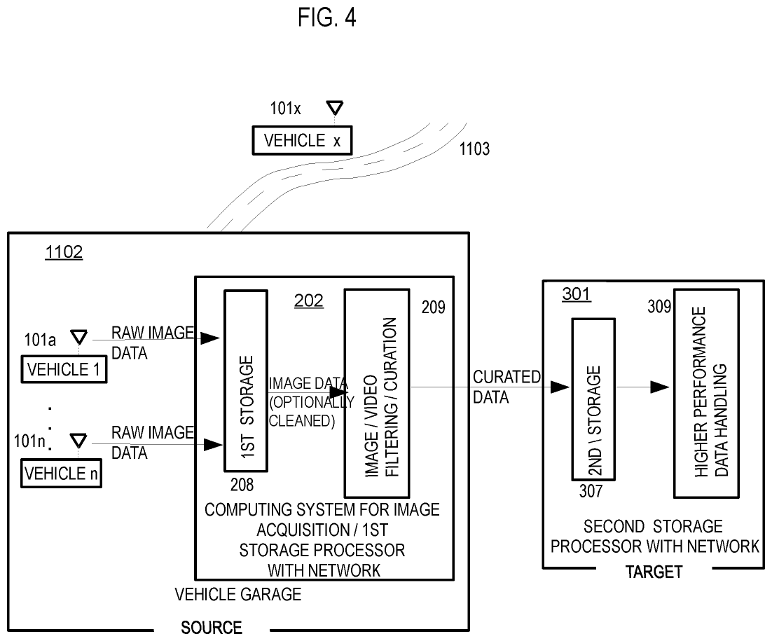

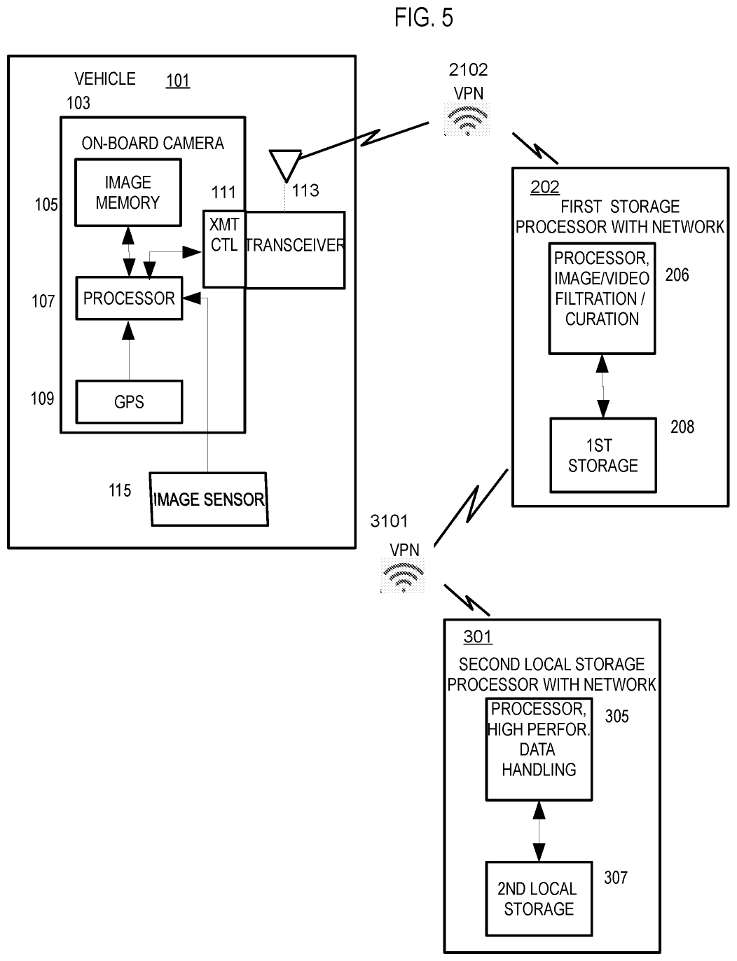

FIG. 4 and FIG. 5 disclose a second embodiment in which FIG. 4 is an overview of the embodiment and FIG. 5 provides additional discussion regarding implementation of the on-board camera, the local network, the first storage processor, and a second storage processor.

Referring now to FIG. 4, a diagram illustrating a simplified and representative environment for acquisition of images from on-board cameras according to a second embodiment will be discussed and described. The following discussion may omit elements which have already been described. FIG. 4 illustrates vehicles 101a to 101n, 101x which are examples of traveling vehicles equipped with on-board cameras, a road 1103, a computing system 202 for image acquisition/first storage processor 202 with network, first storage 209 which may be, e.g., local or remote, a feature of image/video filtering/curation 209, a second storage processor 301 with network, a second storage 307, and functionality for higher performance data handling 309, a vehicle garage 1102 as an example of traveling vehicle parking) equipped with a private network (e.g., a virtual private network, a local area network, or a business network) and the computing system 202 for image acquisition which includes an image/video filtration/curation feature.

An acquisition of raw image data from the vehicles 1 to n 101a, 101n may proceed as described above. In this embodiment by comparison to the first embodiment, the raw image data is instead acquired by the computing system 202 which includes in the first storage 208 which is provided locally instead of in the cloud. The raw image data which is acquired by the computing system 202 may be stored as raw image data in the first storage 208; the first storage could be local, remote, or in a cloud. The raw image data may be cleaned before being stored in the first storage 207 or 208. Techniques are known to those of skill for cleaning image data.

In this second embodiment, the raw image data stored in the first storage 208 may be further processed. For example, the computing system 202 may run the image data from the first storage 208 through a mini machine learning model, may filter the image data, and/or may curate the image data to be limited to data of interest to a corresponding process, for example for the day, reducing the size of the data in storage being transferred. After machine learning, filtering, curation, and/or size reduction is finalized, the computing system 202 may send the data to a second storage processor 301 with the second storage 307 and higher performance data handling 309. This may trigger the second storage processor 301 to perform the high-performance data handling 309 to process the, e.g., curated data, on a more powerful model. This entire process for acquisition of raw image data into highly processed data may have a turnaround of about one day for each day's set of image data.

Referring now to FIG. 5, a block diagram illustrating portions of an on-board camera and networks arranged for acquisition of images according to the second embodiment will be discussed and described. FIG. 5 illustrates a vehicle 101, the first storage processor 202 with network, and a second local storage processor 301 with network.

The vehicle 101, on-board camera 103, the image memory 105, the processor 107, the global positioning system 109, the transmission control 111, the transceiver 113, and the image sensor 115 may be as discussed in connection with the first embodiment, and thus are not further described in the second embodiment.

The first storage processor 202 with network may include a processor 206 which receives the raw image data over the virtual private network 2102, and which includes one or more features to further processor the image data in accordance with, for example, data analysis, image/video filtering, curation, machine learning, and/or model processing.

The on-board camera 103 will not connect to the virtual private network 2102 which has a limited range unless the on-board camera is in range, for example, in the garage, or in a specific area of the garage, associated with the virtual private network 2102 and the first storage 208. The duration that the vehicle 101 is parked in the garage is expected to be at least sufficient for transmitting the raw image data stored in the image memory 105 to the first storage processor 202 over the virtual private network 2102.

The second local storage processor 301 includes a network, here represented by a virtual private network 3101, includes a processor 305 which may perform high performance data handling or specific purpose data handling, and a second storage 307, which may be local (as illustrated) or remote, for storage of the data which has been further processed by the high performance data handling processor 305.

Accordingly, a high accuracy detection model on the image data may be processed at a fast pace while avoiding the high cost incurred by data transfer using a mobile network. This provides a fast turn-around while minimizing data-transfer cost of a mobile network, maintaining the use of a high-performance computer (HPC) which may be in-house to process the data, and prevent storage issues on cameras.

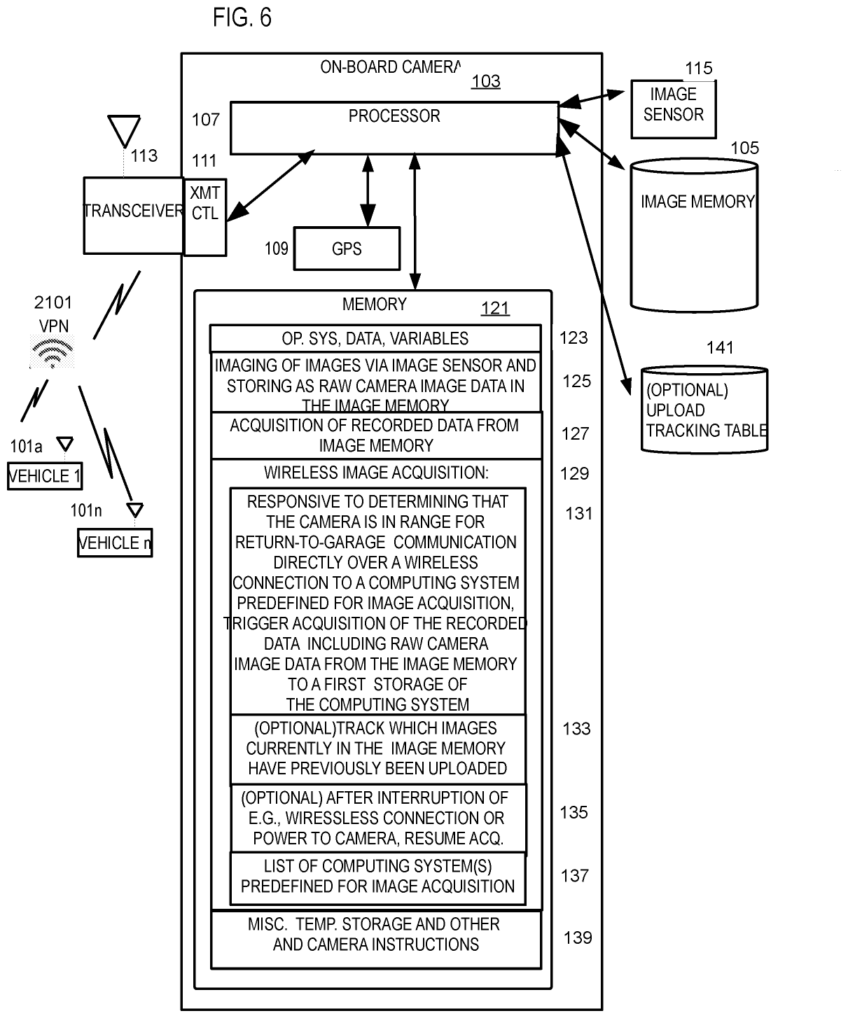

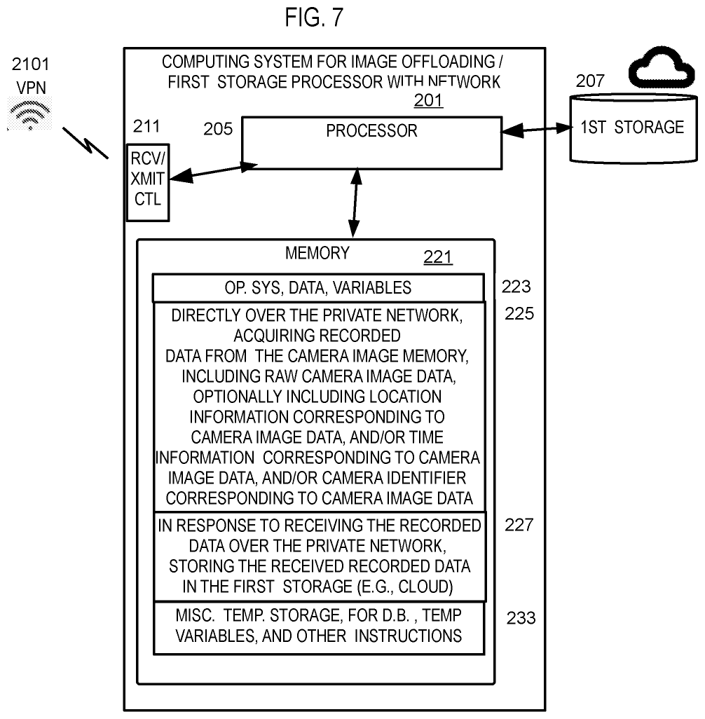

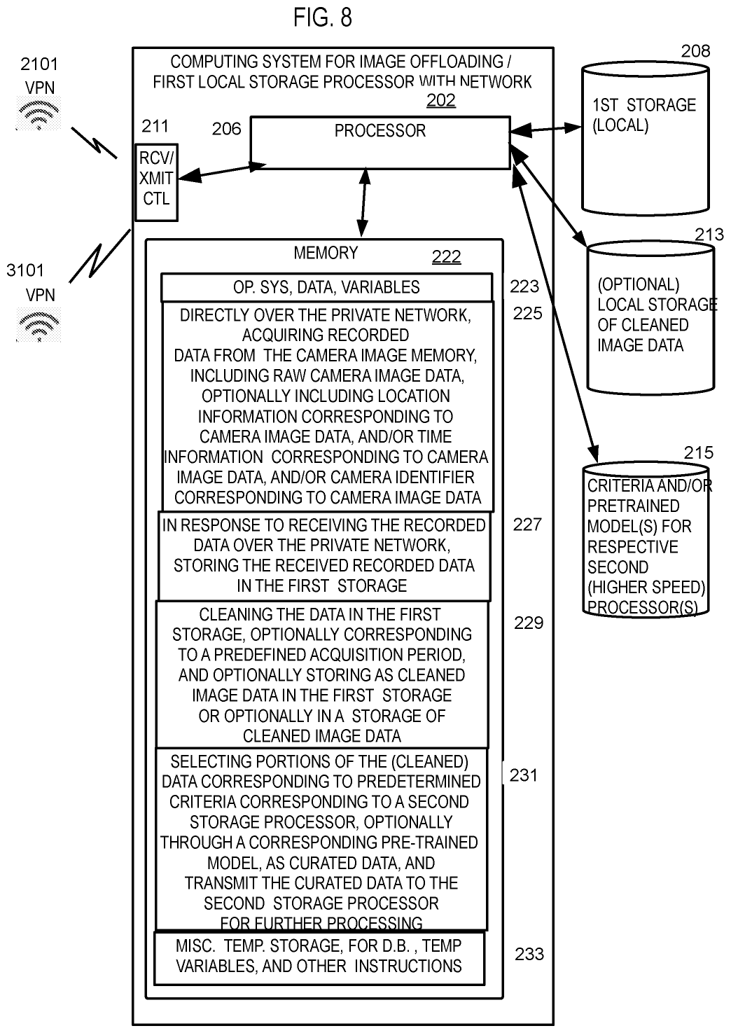

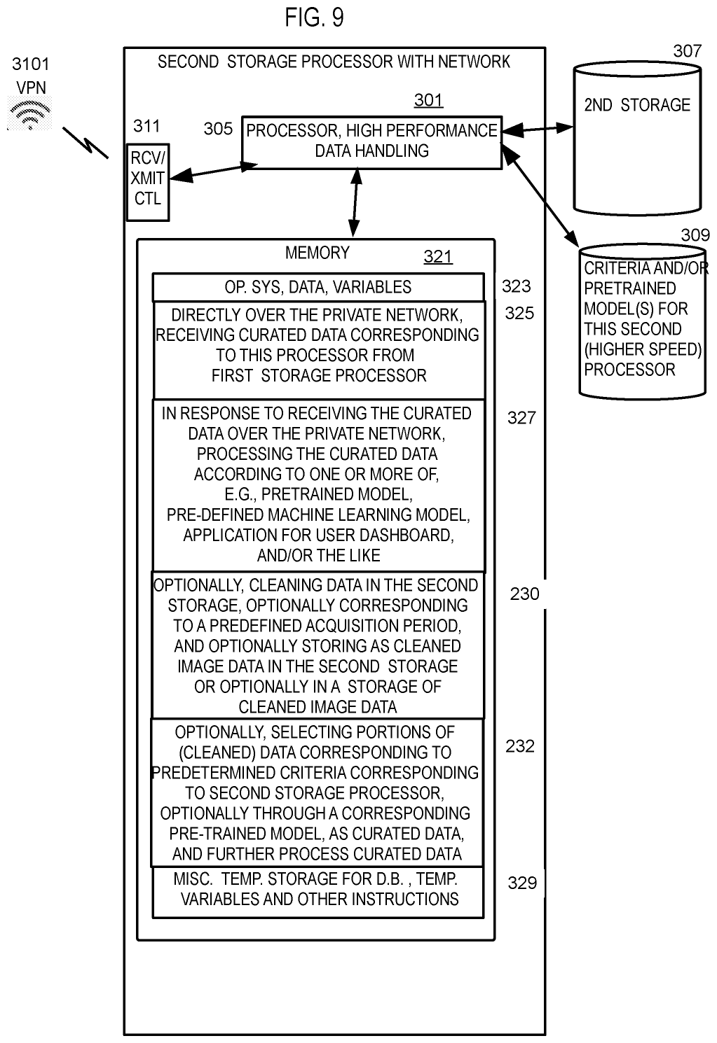

Block diagrams illustrating portions of the on-board camera of the first and second embodiments (FIG. 6), the computing system of the first embodiment (FIG. 7), the computing system of the second embodiment (FIG. 8), and the second storage processor of the second embodiment (FIG. 9) are now discussed.

Referring now to FIG. 6, a block diagram illustrating portions of the on-board camera will be discussed and described. Elements which have been discussed above may be omitted. An on-board camera 103 may include an image memory 105, one or more processors 107, a GPS 109, a transmission control 111 for communication over a transmitter or transceiver 113 such as over a virtual private network 2101 which communicates with on-board cameras on additional vehicles 101a to 101n, an image sensor 115, and an optional upload tracking table 141. The image sensor 115 is representative of a sensor that images the images which are then stored as recorded image data in the image memory 105. The recorded image data in the image memory 105 may be stored as a raw file or raw files, which may be video or stills, and which may be uncompressed and not generally viewable by a user without further processing, although conceivably a camera may store its raw images after some minimal amount of processing; for example, raw image files may store the data as read out from pixels of the on-board camera's image sensor 115. Portions of the on-board camera 103 are well understood to those of skill in this area and have been omitted to avoid obscuring the discussion.

The image memory 105 may be provided as an automatic round-robin storage, and/or for storage in orders as will be understood by those of skill. Alternatively, the image memory 105 may support off-loading whereby offloading an image automatically frees up the data location for overwriting. An image memory 105 may store, for example 128 GB.

The processor 107 may comprise one or more microprocessors and/or one or more digital signal processors. The memory 121 may be coupled to the processor 107 and may comprise a read-only memory (ROM), a random-access memory (RAM), a programmable ROM (PROM), and/or an electrically erasable read-only memory (EEPROM). The memory 121 may include multiple memory locations for storing, among other things, an operating system, data and variables 123 for programs executed by the processor 107; such programs can include one or more of the following: imaging 125 of images; acquisition 127 of recorded image data; wireless image acquisition 129; and a temporary storage 139 for other information and/or camera instructions used by the processor 107. The computer programs may be stored, for example, in ROM or PROM and may direct the processor 107 in controlling the operation of the on-board camera 103. Each of these functions is considered in more detail herein, to the extent that it is not detailed elsewhere in this document.

The on-board camera 103 can image 125 images via the image sensor 115, as image data which includes images sensed by, for example, pixels of the image sensor 115; the sensed image data is stored as raw camera image data in the image memory 105 as recorded image data. “Raw” indicates that the data is stored as acquired by the on-board camera without further processing by the processor 107 other than that, if any, provided as part of the camera's own storage process.

The on-board camera 103 can support acquisition 127 of recorded image data, from the image memory 105, by transmission over the transceiver 113 such as to the virtual private network 2101.

The processor 103 of the on-board camera 103 may be programmed to provide wireless image acquisition 129. The wireless image acquisition 129 may be provided as an app added to the on-board camera, or may be provided as special programming for the on-board camera. The wireless image acquisition 129 can include, responsive 131 to determining that the on-board camera 103 is in range for return-to-garage communication directly over a wireless connection to a computing system, trigger an acquisition of the recorded image data including the raw camera image data from the image memory 105 over the vpn 2101 to a first storage of the computing system. The computing system or network may be pre-defined for image acquisition, so that the images are acquired by only a pre-approved system. For example, the memory 121 may store a list 137 of one or more computing systems (and/or networks) which are predefined for image acquisition, thus providing a measure of security. The wireless image acquisition 129 instructs the on-board camera to control the power to remain powered on until the image acquisition process (of this cycle) is complete, and thereafter can allow the on-board camera to power down. Otherwise an on-board camera might automatically power-down and (at least) cease providing power to the transceiver 113, for example, when motion ceases, when image acquisition ceases, or the vehicle is turned off (if the on-board camera is powered by the vehicle engine).

The processor 103 of the on-board camera 103 may be programmed so that the wireless image acquisition 129 may include an optional feature which will track 133 which images currently in the image memory 105 were previously uploaded, for example, in the optional upload tracking table 141. To “upload” means that the area of memory where the uploaded image data is stored is not automatically freed up. In this case, when transmitting the recorded image data from the image memory 105 over the vpn 2101, the processor may including information identifying which image data in the image memory 105 has been transmitted, optionally successfully acknowledged by the first storage processor, thereby to avoid unnecessary re-transmissions of already-transmitted image data, and/or thereby to support re-transmission of unsuccessfully transmitted image data, and/or thereby to overwrite new image data onto areas of already-transmitted image data.

The processor 103 of the on-board camera 103 may be programmed so that the wireless image acquisition 129 may include an optional interruption 135 recovery feature which, after an interruption to image acquisition over the vpn 2101, such as an interruption of the wireless connection, an interruption of power to the on-board camera, causes a resumption of image acquisition. The wireless image acquisition 129 may track where it was in the image acquisition process, for example, by memory location, or by date/time. Once an image acquisition has completed normally, at the next image acquisition (for example, after the next return to the garage), the wireless image acquisition 129 will begin the image acquisition from that point (to avoid duplicating data). Each recorded image data (e.g., a video or data point) may have a unique identity in the image memory 105, and the wireless image acquisition 129 will be aware of which image data has not yet been acquired by the first storage processor.

Referring now to FIG. 7, a block diagram illustrating portions of the computing system for image acquisition/first storage processor with network according to the first embodiment will be discussed and described. The computing system 201 may include a receive/transmit control 211 for communication over a network (here represented by the virtual private network 2101), a processor 205, and a memory 221. The computing system 201 may include other devices as will be well understood which have been omitted to avoid obscuring the discussion.

The processor 205 may comprise one or more microprocessors and/or one or more digital signal processors. The memory 221 may be coupled to the processor 205 and may comprise a read-only memory (ROM), a random-access memory (RAM), a programmable ROM (PROM), and/or an electrically erasable read-only memory (EEPROM). The memory 221 may include multiple memory locations for storing, among other things, an operating system, data and variables 223 for programs executed by the processor 205; computer programs for causing the processor to operate in connection with various functions such as acquiring 225 recorded data from the camera image memory, and storing 227 the received recorded image data; and temporary storage 233 for a database, temporary variables, and other instructions and information used by the processor 205. The computer programs may be stored, for example, in ROM or PROM and may direct the processor 205 in controlling the operation of the computing system 201.

Responsive to signaling over the receive/transmit control 211, in accordance with instructions stored in memory 221, or automatically upon receipt of certain information via the receive/transmit control 211, the processor 205 may direct the stored information or received information.

The processor 205 may be programmed to acquire 225 recorded data from the camera image memory. For example, the computing system 201 may, directly over the local area network such as vpn 2101, acquire the recorded image data from the camera image memory, including raw camera image data. Optionally, the acquired data may including location information indicating a location where the camera image data was acquired by the on-board camera, and/or time information indicating a date/time of acquisition of the camera image data by the on-board camera, and/or a camera identified uniquely identifying the on-board camera as corresponding to the camera image data.

The processor 205 may be programmed to store 227 the received recorded image data. In response to receiving the recorded image data over the local area network, such as the vpn 2101, the processor 205 may store the image data which was received, onto the first storage 207, here such as stored in the cloud, although such storage could be local or distributed or remote. The processor 205 may store the received image data onto the first storage 207 as such image data is received.

Referring now to FIG. 8, a block diagram illustrating portions of the computing system for image acquisition/first storage processor with network according to the second embodiment will be discussed and described. Descriptions of portions of the computing system 202 of the second embodiment which are similar to those of the first embodiment are omitted. The processor 206 and memory 222 of the second embodiment includes features and programming analogous to the processor 205 and memory 222 of the first embodiment, which are omitted from the discussion.

Further, the receive/transmit control 211 may communicate with the local area network 2101, here represented by a vpn, of the first storage processor 202 and a local area network 3101, here represented by a vpn, of the second storage processor.

Further, computer programs stored in the memory 221 may include programs as described in connection with the first embodiment, and further for causing the processor to operate in connection with various functions such as cleaning 229 the data in the first storage 208, and/or selecting 231 portions of the data for a curated data feature, as further described below.

The processor 206 may be programmed to clean 229 the raw image data in the first storage 208. The data which the processor cleans may correspond to a predefined acquisition period (for example, one day). Optionally, the processor 206 may store the cleaned image data in back into the first storage 208. Optionally, the processor 206 may store the cleaned image data in a local storage 213 of the cleaned image data. Techniques for cleaning image data will be well understood to those of skill in the art.

The processor 206 may be programmed to select 231 portions of the image data for a curated data feature. The data selected for the curated data feature may be selected from the stored image data of the first storage 208, or the cleaned stored image data of the cleaned image data storage 213. The portions of the data which are selected, as curated data, may correspond to predetermined criteria corresponding to a second storage processor, such that only portions of the data which are relevant to further processing may be selected. A criteria and/or pretrained model storage 215 may be provided which stores criteria and/or pretrained models for respective second processors, which may be higher speed processors. The curated data may be transmitted to the second storage processor, for example, over the second local area network 3101, for further processing of the curated data by the corresponding second storage processor.

Responsive to signaling over the receive/transmit control 211, in accordance with instructions stored in memory 222, or automatically upon receipt of certain information via the receive/transmit control 211, or automatically upon expiration of a predetermined period, the processor 206 may perform the cleaning 229 and/or curation 231.

Referring now to FIG. 9, a block diagram illustrating portions of the second storage processor with network will be discussed and described. Descriptions of portions of the second storage processor 301 which may be similar to those of the computing system 202 may be omitted or abbreviated. A processor 305 and a memory 321 of the second storage processor may include features and some programming analogous to the processor 205 and memory 222 of the computing system 202, which are omitted from the discussion. The second storage processor 301 may include the processor 305, which may include high performance data handling; and a receive/transmit control 311.

The receive/transmit control 311 may communicate with the local area network 3101, here represented by a vpn, of the computing system.

The memory 321 may include multiple memory locations for storing, among other things, an operating system, data and variables 323 for programs executed by the processor 305; computer programs for causing the processor 305 to operate in connection with various functions such as receiving curated data 325, processing the curated data 327, optionally cleaning data in the second storage 230, and optionally preparing and processing curated data 232; and temporary storage 329 for a database, temporary variables, and other instructions and information used by the processor 305. The computer programs may be stored, for example, in ROM or PROM and may direct the processor 305 in controlling the operation of the second storage processor 301.

Responsive to signaling over the receive/transmit control 311, in accordance with instructions stored in memory 321, or automatically upon receipt of certain information via the receive/transmit control 311, the processor 305 may direct the stored information or received information.

The processor 305 may be programmed to receive curated data 325, directly over the network 3101, here represented by the vpn 3101, from the first storage processor. The curated data which is received should have been selected by the first storage processor according to criteria corresponding to the second storage processor.

The processor 305 may be programmed to, in response to receiving the curated data over the network, process the curated data 327 according to one or more of, for example, a pretrained model, a pre-defined machine learning model, an application for a user dashboard for user-friendly presentation of information, and/or the like.

Optionally, the processor 305 may be programmed to clean data 230 in the second storage 307. This feature is analogous to a feature of cleaning data 229 on the computing system of FIG. 8. It is possible for this feature to be programmed and/or performed on either (or both) the computing system of FIG. 8, or the second storage processor 301. Cleaned data may be stored in the second storage 307.

Optionally, the processor 305 may be programmed to prepare and process curated data 232. This feature is analogous to the curated data feature 231 on the computing system of FIG. 8. It is possible for this feature to be programmed and/or performed on either (or both) the computing system of FIG. 8, or the second storage processor 301. A criteria and/or pretrained model storage 309 may be provided which stores criteria and/or pretrained models corresponding to this second processor, which may be a higher speed processor than the computing system of, e.g., FIG. 8. In this option, portions of the cleaned data corresponding to the predetermined criteria are selected, and/or the curated data is received over the second local area network 3101; the curated data is then further processed according to the criteria and/or pretrained model 309.

Thus, more compute-intensive processing of image data may be performed, such as on batches of the image data which is received, which may or may not have been cleaned already, and which may or may not have been curated already for this specific system.

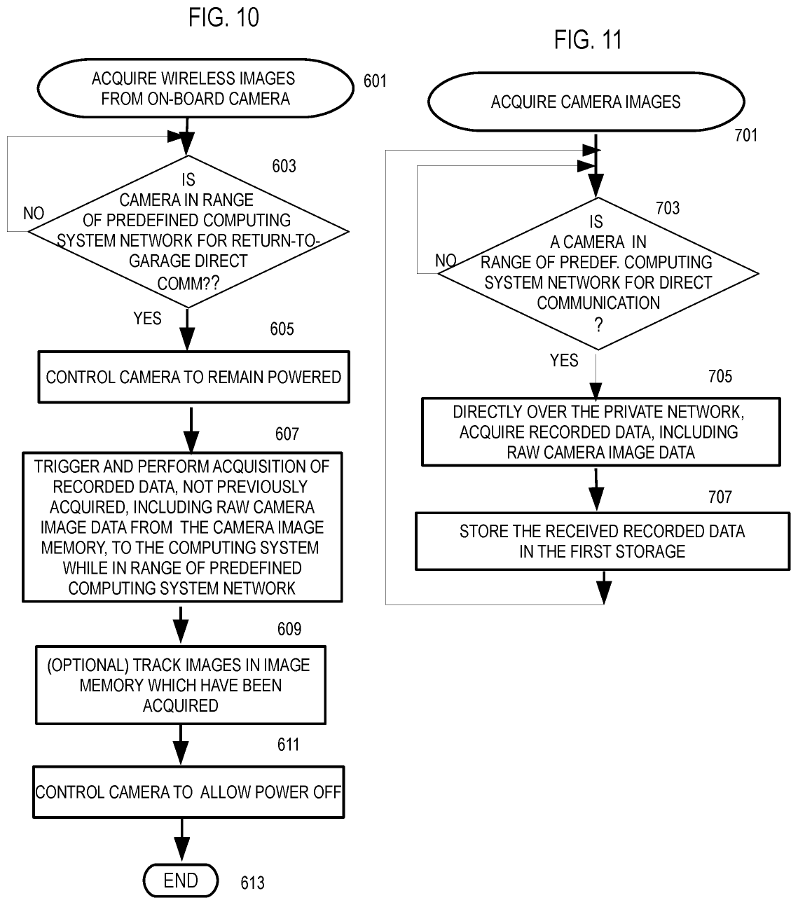

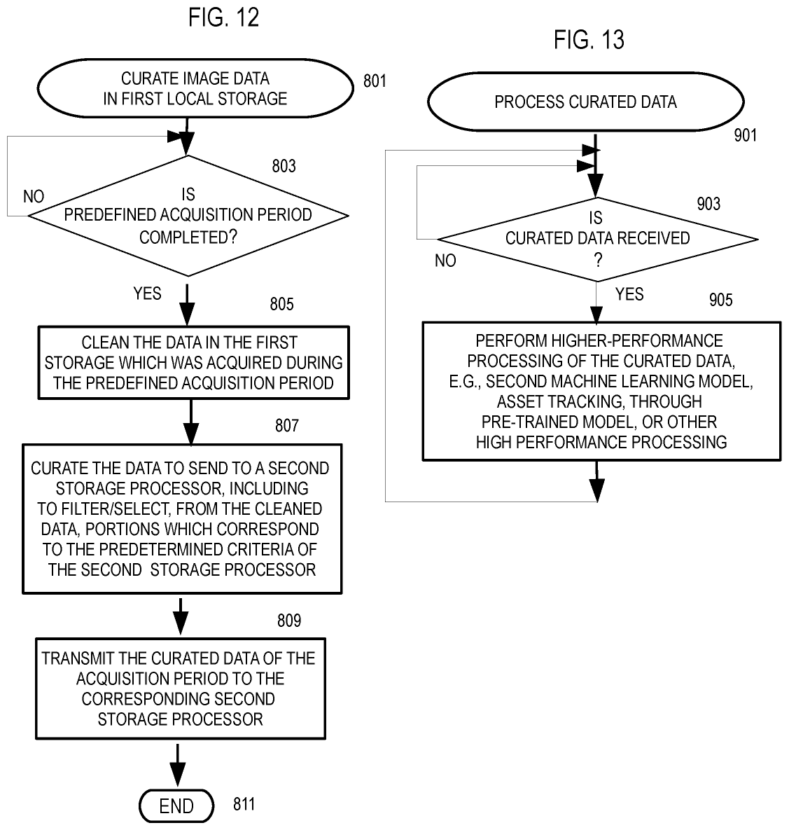

Reference is now made to FIG. 10 to FIG. 13 which provide flow charts of the process. FIG. 10 is a flow chart relating to the on-board camera, advantageously implemented on, for example, a processor of the on-board camera, described in connection with FIG. 6, or other apparatus appropriately arranged. FIG. 11 is a flow chart relating to acquiring the camera image data from the on-board camera, advantageously implemented on, for example, the processor of the first storage processor described in connection with FIG. 7 or FIG. 8, or other apparatus appropriately arranged. FIG. 12 is a flow chart relating to curating the image data, advantageously implemented on, for example, the first storage processor described in connection with FIG. 8, or other apparatus appropriately arranged. FIG. 13 is a flow chart relating to processing the curated data performed by the second storage processor, advantageously implemented on, for example, the second storage processor described in connection with FIG. 9, or other apparatus appropriately arranged.

Referring now to FIG. 10, a flow chart illustrating a procedure to acquire 601 wireless images from an on-board camera, performed on the on-board camera will be discussed and described. Advantageously, the procedure may be implemented as an app loaded onto the camera, or otherwise programmed for providing control of the on-board camera.

The procedure includes determining 603 whether the camera is in range of a predefined computing system network, for return-to-garage direction communication. For example, if a computing system network is detected, the procedure may include determining whether the detected computing system network is predefined to be used for return-to-garage direct communication. The computing system network may be a local area network with limited range, such that once the vehicle has returned to the garage, the computing system network may be detected. The procedure may loop until the computing system network is detected.

The procedure may include, once the predefined computing system network for return-to-garage direct communication is detected, controlling 605 the camera to remain powered on. One of skill will understand that on-board cameras may include a command to remain powered on, such that wireless communications may occur.

The procedure may include triggering 607 and performing acquisition of the recorded data, not previously acquired, including raw camera image data from the camera image memory, to the computing system, while in range of the predefined computing system network. For example, the performing acquisition by the computing system may include the on-board camera performing any necessary handshaking with the computing system network, and transmitting the raw camera image data from the camera image memory over the network which is connected. The transmitting of raw camera image data has been described in more detail above.

In some embodiments, the procedure may include tracking 609 images in the image memory which have been acquired, that is, which have been transmitted over the computing system network. Tracking has been described in more detail above.

The procedure may include controlling 611 the camera to power itself off, or to allow the camera to automatically power itself off.

Then, the procedure may end 613, the images from the on-board camera having been acquired by the computing system. The procedure will be prepared to repeat for example when the vehicle on which the on-board camera is mounted leaves the garage and returns after, e.g., performing a round trip and detecting the return-to-garage direct communication 603.

Referring now to FIG. 11, a flow chart illustrating a procedure to acquire 701 camera images, performed on the first storage processor will be discussed and described.

The procedure to acquire 701 camera images may include determining 703 whether a camera is in range of a predefined computing system network for direct communication. The procedure may loop until a camera in range of the computing system network is detected.

The procedure includes, once a camera is determined to be in range, then directly 705 over the private network, acquiring the recorded image data, including the raw camera image data, namely, receiving the recorded image data which is received over the private network.

The procedure includes storing 707 the received recorded image data, which is raw image data, in the first storage. While a camera is determined 703 to be in range for direct communication, the procedure continues to directly 705 acquire the recorded image data and store 707 the received image data into the first storage.

It will be noted that the procedure 701 may received data from one or mor cameras which are in range of the predefined computing system network. Thus, multiple vehicles in a fleet may be providing their respective camera image data to the first storage processor.

Referring now to FIG. 12, a flow chart illustrating a procedure to curate image data in the first storage, performed on the first storage processor, will be discussed and described.

The procedure includes determining 803 whether a predefined acquisition period is completed. Such an acquisition period could be correlated to the general round trip timing, e.g., once a day, or could be, for example, a predefined number of days. The procedure will loop until the predefined acquisition period is completed.

The procedure includes, once the predefined acquisition period is completed, cleaning 805 the data in the first storage which was acquired during the predefined acquisition period. Techniques for cleaning image data are well understood by those of skill in the art. Cleaning may advantageously be limited to the most recent acquisition period.

The procedure includes curating 807 the cleaned image data to send to a second storage processor. The curating may including filtering and/or selecting, from the cleaned data, portions of the image data which correspond to predetermined criteria of a specific second storage processor. Data may be curated differently for different second storage processors which may perform different high performance processing on the data.

The procedure includes transmitting 809 the curated data corresponding to the acquisition period, to the corresponding second storage processor for which the data was curated.

Referring now to FIG. 13, a flow chart illustrating a procedure to process 901 curated data, performed on the second storage processor, will be discussed and described.

The procedure includes determining 903 whether curated data is received. The procedure will loop until curated data is being received.

The procedure includes, once it is determined that curated data is received, performing 905 higher-performance processing of the curated data. Such higher-performance processing can include one or more of, for example, a second machine learning model, asset tracking, analysis through a pre-trained model, or other high performance processing.

Consequently, processing-intensive tasks of related to cleaning, curating, and analyzing the image data are separated from any possible edge processing by the on-board camera, resulting in an efficient flow which takes advantage noted by the present inventors that there is a possibly significant window when the vehicles remain in the garage between their respective traveling routes.

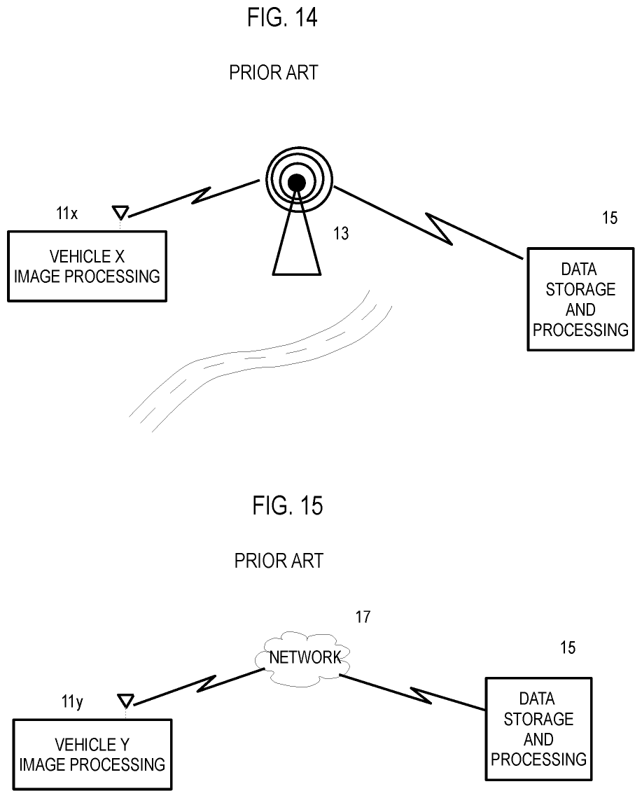

Referring now to FIG. 14, a diagram illustrating a prior art processing of camera images by the on-board unit and the uploading to the data storage and processing, while on the road through a cellular connection will be discussed and described. A vehicle X 11x includes an on-board camera, which collects the raw image data and then further processes the raw image data. In this system, the on-board camera on the vehicle which is traveling on a road connects with a cellular system 13 and transmits the processed image data, via the cellular system 13, to the data storage and processing 15.

Referring now to FIG. 15, a diagram illustrating a prior art processing of camera images by the on-board unit and the uploading to the data storage and processing through a cloud network will be discussed and described. A vehicle Y 11y includes an on-board camera, which collects the raw image data and then further processes the raw image data. In this system, the on-board camera on the vehicle which is traveling connects with a network 17 and transmits the processed image data, via the network 17, to the data storage and processing 15.

The term “computer system” or “computer” used herein denotes a device sometimes referred to as a computer, laptop, personal computer, tablet computer, handheld computer, smart phone, personal digital assistant, notebook computer, personal assignment pad, server, client, mainframe computer, minicomputer, or evolutions and equivalents thereof.

The phrase “automatically without manual intervention,” when used in a claim, is defined to mean that the particular step without requiring a user to provide direct or indirect instruction to a processor or to otherwise intervene.

One or more of the storage discussed above may be non-volatile storage and may include one or more of the following: a hard disk drive, a solid-state drive, a CD ROM, a digital video disk, an optical disk, a removable storage device such as a USB memory stick, a flash memory, a read-only memory (ROM), a random-access memory (RAM), a programmable ROM (PROM), and/or electrically erasable read-only memory (EEPROM), variations and evolutions thereof. The number and type of drives and removable storage may vary, typically with different computer configurations. Storage may be connected wirelessly and/or may be interconnected by a bus along with other peripheral devices supported by the bus structure and protocol (not illustrated). The bus can serve as the main information highway interconnecting other components, and can be connected via an interface to a computer. A disk controller (not illustrated) can interface disk drives to the system bus.

Much of the inventive functionality and many of the inventive principles when implemented, are best supported with or in software or one or more integrated circuits (ICs), such as a central processing unit (CPU) which is the hardware that carries out instructions of a computer program which may be stored in a memory and loaded into the CPU, and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, discussion of such software and ICs, if any, will be limited to essentials with respect to the principles and concepts used by the exemplary embodiments.

The various embodiments which demonstrate an on-board camera, storage processor, method for wireless acquisition of image, and/or system and/or non-transitory computer-readable medium for the same have been discussed in detail above. It should be further noted that the above-described processes can be stored as instructions in a computer-readable storage medium. When the instructions are executed by a computer, for example after being loaded from the computer-readable storage medium, the process(es) are performed. The detailed descriptions, which appear herein, may be presented in terms of program procedures executed on a computer or a network of computers. These procedural descriptions and representations herein are the means used by those skilled in the art to most effectively convey the substance of their work to others skilled in the art.

A procedure is generally conceived to be a self-consistent sequence of steps leading to a desired result. These steps are those requiring physical manipulations of physical quantities. Usually, though not necessarily, these quantities take the form of electrical or magnetic signals capable of being stored on non-transitory computer-readable media, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms such as adding or comparing, which may sometimes be asserted to be mental operations performed by a human operator. While the discussion herein may contemplate a human, a human operator is not necessary, or desirable in most cases, to perform the actual functions described herein; the operations are machine operations.

Various computers or computer systems may be programmed with programs written in accordance with the teachings herein, or it may prove more convenient to construct a more specialized apparatus to perform the required method steps. The required structure for a variety of these machines will be apparent from the description given herein.

A computer-readable storage medium is tangible and non-transitory; a computer-readable storage medium can be any of the memory or storage devices, such as those examples described above, or other removable or fixed storage medium now known or heretofor conceived, and variations thereof, provided that such computer-readable storage medium is tangible and non-transitory.

Furthermore, any communication network implicated in an embodiment, unless otherwise limited, can include, by way of example but not limitation, data and/or packet communications networks, which can provide wireless communications capability and/or utilize wireline connections such as cable and/or a connector, or similar. Any appropriate communication protocol may be used.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

Any presently available or future developed computer software language and/or hardware components can be employed in various embodiments. For example, at least some of the functionality discussed above could be implemented using C, C++, Java, C#, SQL, R, or any assembly language appropriate in view of the processor being used.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An on-board camera in a business network for wireless acquisition of images from cameras installed on traveling vehicles which image while traveling, the network including a first storage processor which, responsive to the on-board camera being in range for direct wireless communication therewith, acquires recorded image data from an image memory of the on-board camera, the on-board camera comprising:
the image memory; and
at least one processor and/or circuitry configured to
store raw camera image data as recorded data in the image memory of the on-board camera;
determine whether the on-board camera is in range for returned-to-garage communication directly over a wireless connection to a computing system predefined for image acquisition;
responsive to determining that the on-board camera is in range, trigger an acquisition communication of the recorded data from the image memory to a storage of the computing system; and
perform the acquisition communication, responsive to being triggered, of the recorded data from the image memory;
wherein the recorded data which is communicated by the acquisition communication includes the raw camera image data.

2. The on-board camera of claim 1, wherein the at least one processor and/or circuitry is further configured to
upload, as the acquisition communication, the images from the image memory;
track which among the images in the image memory have been uploaded to the storage of the computing system,
wherein the images which are uploaded are those which are determined to have not been previously transmitted.

3. The on-board camera of claim 1, wherein the at least one processor and/or circuitry is further configured to
offload, as the acquisition communication, the images from the image memory;
track which among the images in the image memory have been offloaded to the storage of the computing system so as to recover from an interruption of the acquisition communication.

4. The on-board camera of claim 1, wherein the at least one processor and/or circuitry is further configured to maintain power-on to the on-board camera for a duration of the acquisition communication of the recorded data to the storage of the computing system.

5. The on-board camera of claim 1, wherein the at least one processor and/or circuitry is further configured to, after an interruption of the wireless connection and/or after an interruption of power to the on-board camera, resume the acquisition communication of the recorded data from the image memory of the at least one camera to the storage of the computing system.

6. The on-board camera of claim 1, wherein recorded data which is communicated by the acquisition communication further includes location data where the image was acquired, a camera identification identifying the on-board camera which corresponds to the raw camera image data, and a date corresponding to the raw camera image data.

7. A first storage processor in a business network for wireless acquisition of images from on-board cameras installed on traveling vehicles which image while traveling, the first storage processor comprising:
a memory; and
at least one first storage processor and/or circuitry configured to
responsive to at least one camera of the on-board cameras being in range for direct wireless communication therewith, acquire the recorded data from an image memory of the at least one camera to a first storage, wherein the recorded data which is acquired includes the raw camera image data.

8. The first storage processor of claim 7, wherein the at least one first storage processor and/or circuitry is further configured to
select, from the data in the first storage, portions of the data corresponding to predetermined criteria of a second storage processor as curated data, and
transmit the curated data to the second storage processor.

9. The first storage processor of claim 7, wherein the at least one first storage processor and/or circuitry is further configured to
clean the data in the first storage which has been acquired during a predefined acquisition period, prior to selecting from the data in the first storage as the curated data.

10. The first storage processor of claim 7, wherein the at least one first storage processor and/or circuitry is further configured to
process the data on the first storage according to a predefined model corresponding to the second storage processor, and transmit the processed data to the second storage processor over a wireless connection.

11. The first storage processor of claim 7, wherein the at least one first storage processor and/or circuitry is further configured to
responsive to the predefined acquisition period expiring,
perform the selecting of the curated data and the transmitting of the curated data.

12. A method for providing wireless acquisition of images from at least one camera installed on a traveling vehicle which images while traveling, comprising:
by the on-board camera having an image memory and at least one processor and/or circuitry,
storing raw camera image data as recorded data in the image memory of the on-board camera;
determining whether the on-board camera is in range for returned-to-garage communication directly over a wireless connection to a computing system predefined for image acquisition;
responsive to determining that the on-board camera is in range, triggering an acquisition communication of the recorded data from the image memory to a storage of the computing system; and
performing, responsive to being triggered, the acquisition communication of the recorded data from the image memory;
wherein the recorded data which is communicated by the acquisition communication includes the raw camera image data.

13. The method of claim 12, further comprising, by the on-board camera,
tracking which among the images in the image memory have been transmitted to the storage of the computing system,
wherein the images which are transmitted are those which are determined to have not been previously uploaded.

14. The method of claim 12, further comprising, by the on-board camera, maintaining power-on to the on-board camera for a duration of the acquisition communication of the recorded data to the storage of the computing system.

15. The method of claim 12, further comprising, by the on-board camera, after an interruption of the wireless connection and/or after an interruption of power to the on-board camera, resuming the acquisition communication of the recorded data from the image memory of the at least one camera to the storage of the computing system.

16. The method of claim 12, further comprising, by a first storage processor being the predefined computing system,
responsive to the on-board camera being in range of the wireless connection of the predefined computing system for direct wireless communication therewith, acquire the recorded data from the image memory of the at least one camera to a first storage,
selecting, from the data in the first storage, portions of the data corresponding to predetermined criteria of a second storage processor as curated data, and
transmitting the curated data to the second storage processor; and by the second storage processor,
responsive to receipt of the curated data, processing the curated data.

17. The method of claim 16, further comprising, by the first storage processor,
cleaning the data in the first storage which has been acquired during a predefined acquisition period, prior to selecting from the data in the first storage as the curated data.

18. The method of claim 16, further comprising, by the first storage processor,
processing the data on the first storage according to a predefined model corresponding to the second storage processor, and transmitting the processed data to the second storage processor over a further wireless connection.

19. The method of claim 16, further comprising, by the first storage processor, responsive to the predefined acquisition period expiring,
performing the selecting of the curated data and the transmitting of the curated data.

20. The method of claim 16, further comprising, by the second storage processor, processing the curated data according to a predefined machine learning model.
